(19) United States
(12) Patent Application Publication
(10) Pub. No.: US 2008/0248383 A1
(43) Pub. Date: Oct. 9, 2008

(54) BATTERY MODULE

(75) Inventor: Tae-Yong Kim, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/971,391

(22) Filed: Jan. 9, 2008

(30) Foreign Application Priority Data
Apr. 4, 2007 (KR) 10-2007-0033270

(51) Int. Cl. H01M 2/20; H01M 10/36

(52) U.S. Cl. 429/156; 429/149; 429/160

(57) ABSTRACT

A battery module that improves a connection structure of rechargeable batteries to minimize resistance produced at a connection area includes a first rechargeable battery and a second rechargeable battery each having a safety, and a first connection electrode cap that is disposed between the first rechargeable battery and the second rechargeable battery. The first connection electrode cap includes a cap base disposed on the safety of the first rechargeable battery, a connection portion that extends from the cap base toward the second rechargeable battery, the connection portion extending from an inner edge of the cap base, and at least one accommodating portion connected to the connection portion to accommodate the second rechargeable battery.

### CROSS-REFERENCE TO RELATED APPLICATION

This application claims the benefit of Korean Application No. 2007-33270 filed in the Korean Intellectual Property Office on Apr. 4, 2007, the disclosure of which is incorporated herein by reference.

### BACKGROUND OF THE INVENTION

1. Field of the Invention

Aspects of the present invention relate to a battery module, and more particularly, to a battery module having an improved connection structure of rechargeable batteries.

2. Description of the Related Art

In general, several or even tens of rechargeable batteries can be connected to form a battery module. A rechargeable battery is a battery capable of repeating charge and discharge cycles by reversible conversion between chemical energy and electrical energy.

As examples of widely used rechargeable batteries, there are a nickel-cadmium battery, a nickel-hydrogen battery, and a lithium secondary battery. In particular, the lithium secondary battery has an operation voltage of 3.6V or more, which is three times as high as that of the nickel-cadmium battery or the nickel-hydrogen battery. Furthermore, the lithium secondary battery is rapidly growing in the market as a power source of portable electronic devices due to its high energy density per unit weight.

A typical rechargeable battery includes an electrode assembly in which a separator is disposed between an anode and a cathode, a casing having a space for containing the electrode assembly, and an element coupled to the casing to close and seal the casing. According to shapes of the electrode assembly and the casing, the rechargeable battery may be manufactured in various shapes. For example, the rechargeable battery may have a cylindrical shape, a prismatic shape, or a pouch shape.

The battery module constructed with a plurality of rechargeable batteries interconnected with the aforementioned structure has been widely used as a power source for a small-sized portable electronic device (i.e., a cellular phone, a personal computer, and a camcorder, etc.) and a motor-driving power source for a hybrid electric vehicle.

The rechargeable batteries constituting the battery module are interconnected by a connection member. A connection area by which the rechargeable batteries are connected has resistance. The higher the resistance, the poorer the performance of the battery module. Therefore, there is a need for reducing the resistance produced at the connection area, so that performance of the battery module can be improved.

### SUMMARY OF THE INVENTION

Aspects of the present invention have been made in an effort to provide a battery module having an improved connection structure of rechargeable batteries contained therein to minimize resistance produced at a connection area.

According to an aspect of the present invention, there is provided a battery module including a first rechargeable battery and a second rechargeable battery each having a safety, and a first connection electrode cap that is disposed between the first rechargeable battery and the second rechargeable battery. The first connection electrode cap includes a cap base disposed on the safety of the first rechargeable battery, a connection portion that extends from the cap base toward the second rechargeable battery, the connection portion extending from an inner edge of the cap base, and at least one accommodating portion extending from the connection portion to accommodate the second rechargeable battery.

According to an aspect of the present invention, the cap base may have a disc shape with an aperture therethrough.

According to an aspect of the present invention, the connection portion may extend toward the second rechargeable battery about an outside of the casing of the second rechargeable battery. The connection portion may have an open cylinder shape.

According to an aspect of the present invention, the accommodating portion may include a bottom member having a first end connected to an end of the connection portion opposite the cap base, and the bottom member extends outwardly and radially from the end of the connection portion to a second end of the bottom member, and the bottom member is parallel to the cap base, and a lateral member connected to the second end of the bottom member and extends from the second end of the bottom member in a direction away from the cap base.

According to an aspect of the present invention, the accommodating portion may be equally spaced from each adjacent accommodating portion about a circumference of the connection portion. Further, the accommodating portion may be formed in a bent shape, first extending outwardly and radially from the connection portion and then extending therefrom toward the second rechargeable battery.

According to an aspect of the present invention, the first rechargeable battery may further include a gasket. The gasket may surround a periphery of the safety of the first rechargeable battery and a periphery of the cap base.

According to an aspect of the present invention, the safety of the first rechargeable battery may face a lower side of the second rechargeable battery.

According to an aspect of the present invention, the battery module may further include a second connection electrode cap disposed on the safety of the second rechargeable battery, and a fixture fixed to the second connection electrode cap.

According to an aspect of the present invention, the second rechargeable battery may further include a gasket. The gasket may surround a periphery of the safety of the second rechargeable battery and a periphery of the second connection electrode cap.

According to an aspect of the present invention, the second connection electrode cap may include a supporting plate, which is disposed on the safety of the second rechargeable battery and has a vertically hollow shape, and a cover portion protruding from an inner edge of the supporting plate.

According to an aspect of the present invention, the fixture may be fixed to a side of the cover portion nearer the second rechargeable battery. The fixture may be a nut. The fixture may be a bolt having a body and a screw integrated with the body. The body may be fixed to a side of the cover portion nearer the second rechargeable battery and the screw may pass through the cover portion.

According to another aspect of the present invention, there is provided a battery module including a first rechargeable battery, a second rechargeable battery, and a first connection electrode cap. The first rechargeable battery and the second rechargeable battery each have an electrode assembly constructed of an anode, a cathode, and a separator interposed between the anode and the cathode, a casing to contain the electrode assembly, a safety disposed in an upper portion of the casing, and a gasket disposed between the casing and the safety to surround a periphery of the safety. The first connection electrode cap is disposed between the first rechargeable battery and the second rechargeable battery, the first and second rechargeable batteries being disposed in a longitudinal direction, and the first connection electrode cap connects the first rechargeable battery and the second rechargeable battery. A first end of the first connection electrode cap is disposed on the safety of the first rechargeable battery and is surrounded by the gasket of the first rechargeable battery along with the safety, and a second end of the first connection electrode cap is coupled to the casing of the second rechargeable battery.

According to an aspect of the present invention, the first connection electrode cap may include a cap base disposed on the safety of the first rechargeable battery, a connection portion protruding from the cap base, and at least one accommodating portion connected to the connection portion and by which the second rechargeable battery is accommodated.

According to still another exemplary embodiment of the present invention, there is provided a battery module including a first rechargeable battery, a second rechargeable battery, a third rechargeable battery, a first connection electrode cap, a second connection electrode cap, and a conductor.

According to an aspect of the present invention, the first rechargeable battery, the second rechargeable battery, and the third rechargeable battery each have an electrode assembly, a casing to contain the electrode assembly, a safety disposed to an upper portion of the casing, and a gasket surrounding a periphery of the safety.

According to an aspect of the present invention, the first connection electrode cap is disposed between the first rechargeable battery and the second rechargeable battery, the first rechargeable battery and the second rechargeable battery being disposed in a longitudinal direction, and the first connection electrode cap connects the first rechargeable battery and the second rechargeable battery.

According to an aspect of the present invention, the second connection electrode cap is disposed to each of the second rechargeable battery and the third rechargeable battery arranged in a cross or adjacent direction with respect to the longitudinal direction.

According to an aspect of the present invention, the conductor is connected to the second connection electrode cap of the second rechargeable battery and the second connection electrode cap of the third rechargeable battery.

According to an aspect of the present invention, the second connection electrode cap disposed to the second rechargeable battery is disposed on the safety of the second rechargeable battery, and the second connection electrode cap disposed to the third rechargeable battery is disposed on the casing of the third rechargeable battery.

According to an aspect of the present invention, the gasket of the second rechargeable battery surrounds the safety of the second rechargeable battery and a periphery of the second connection electrode cap disposed to the second rechargeable battery.

According to an aspect of the present invention, the second connection electrode cap may include a supporting plate having a disk shape with an aperture therethrough, and a cover portion protruding from an inner edge of the supporting plate.

According to an aspect of the present invention, the second connection electrode cap disposed to the second rechargeable battery may be electrically connected to an anode of the second rechargeable battery, and the second connection electrode cap disposed to the third rechargeable battery is electrically connected to a cathode of the third rechargeable battery.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is an exploded perspective view of a battery module according to an exemplary embodiment of the present invention;

FIG. 2 is a partial cross-sectional view of the first rechargeable battery coupled to the first connection electrode cap shown in FIG. 1;

FIG. 3 is an exploded perspective view of the second rechargeable battery and the second connection electrode cap shown in FIG. 1;

FIG. 4 is a perspective view of a battery module according to another embodiment of the present invention in a state that a nut is coupled to a cover portion of a second connection electrode cap; and

FIG. 5 is a cross-sectional view of a plurality of rechargeable batteries interconnected using a first connection electrode cap and a second connection electrode cap.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

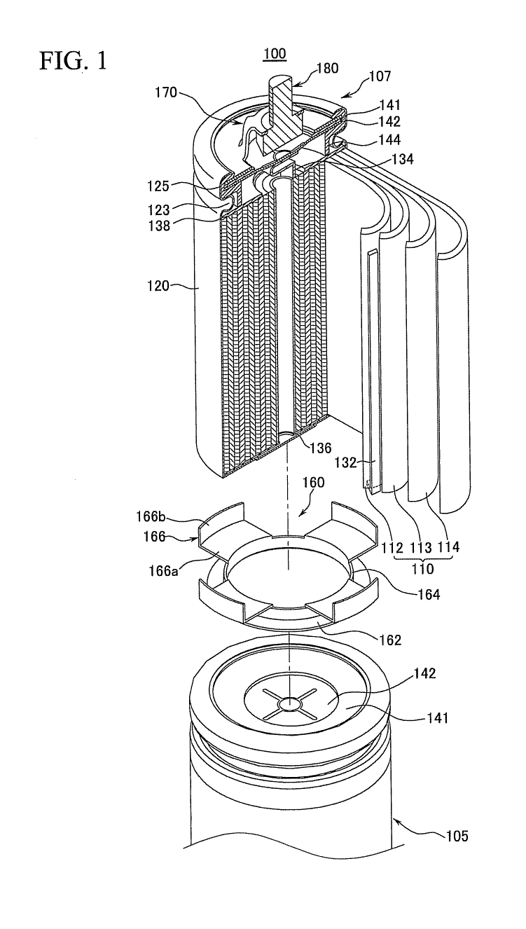

FIG. 1 is an exploded perspective view of a battery module 100 according to an exemplary embodiment of the present invention. The battery module 100 includes a first rechargeable battery 105 and a second rechargeable battery 107 connected with each other by a first connection electrode cap (hereinafter, referred to as a vertical connection electrode cap) 160. The first rechargeable battery 105 and the second rechargeable battery 107 connecting to form the battery module 100 are lithium ion secondary batteries. However, aspects of the present invention are not limited to lithium ion secondary batteries. The battery module 100 may include a plurality of rechargeable batteries.

Referring to FIG. 1, the battery module 100 includes the first rechargeable battery 105 and the second rechargeable battery 107, each having an electrode assembly 110, a casing 120, a safety, including a safety vent 142, and a gasket 144. Further, the battery module 100 includes a second connection electrode cap (hereinafter, referred to as a horizontal connection electrode cap) 170 disposed at an upper portion of the second rechargeable battery 107, and the vertical connection electrode cap 160 is disposed at an upper portion of the first rechargeable battery 105.

In the present embodiment, the first rechargeable battery 105 has the same structure as the second rechargeable battery 107. Thus, the following description of the structure of the first and second rechargeable batteries 105 and 107 will focus on the structure of the second rechargeable battery 107. Reference numerals indicating elements of the second rechargeable battery 107 may also be used to indicate elements of the first rechargeable battery 105.

The electrode assembly 110 includes a cathode 112 in which a cathode active material is attached on a current-collecting plate, an anode 114 where an anode active material is attached on a current-collecting plate, and a separator 113 disposed between the cathode 112 and the anode 114 to prevent a short-circuit between the anode 114 and the cathode 112.

More specifically, the cathode 112 may be manufactured by coating a slurry-type active material layer, that is, a mixture of a powder for the cathode active material, a cathode binder, and a coupling agent, on a current-collecting plate, such as a copper plate. A cathode tab 132 is coupled with the cathode 112. The cathode tab 132 comes in contact with an internal base of the casing 120. Accordingly, the casing 120 acts as a cathode terminal of the rechargeable batteries 105 and 107. A cathode current-collecting plate (not shown) may be connected to the cathode 112 instead of the cathode tab 132.

The anode 114 may be manufactured by uniformly coating a slurry-type active material layer, that is, a mixture of a powder for the anode active material, an anode binder, and an anode conductive additive, on a current-collecting plate, such as an aluminum plate. An anode tab 134 is coupled with the anode 114. The anode tab 134 is drawn out from the anode 114 to contact the safety vent 142. The anode 114 may be connected to an anode current-collecting plate (not shown) instead of the anode tab 134. A lead tab (not shown) of the anode current-collecting plate may be connected to the safety vent 142.

The separator 113 separates the cathode 112 from the anode 114 and provides a lithium ion path. The separator 113 may be composed of a polyethylene layer, a polypropylene layer, or a polyvinylidene fluoride layer. These layers may be laminated to form a multi-layer having two or more layers. The separator 113 may be a double-layered separator of polyethylene/polypropylene, a triple-layered separator of polyethylene/polypropylene/polyethylene, or a triple-layered separator of polypropylene/polyethylene/polypropylene.

The electrode assembly 110 is formed when the cathode 112, the separator 113, and the anode 114 are sequentially laminated, and a center rod (not shown) is then bonded to one end of the lamination result, and the bonded result is then wound to have a substantially cylindrical shape. The finished electrode assembly 110 is inserted into the casing 120, to be described below, and the center rod is then removed from the electrode assembly 110. A center pin (not shown) may be inserted into the hollow portion that is formed when the center rod is removed.

Upper and lower insulating plates 138 and 136 are disposed at the upper and lower portions of the electrode assembly 110, respectively, so as to prevent a short-circuit between the electrode assembly 110 and the casing 120.

The casing 120 has a substantially cylindrical shape and includes a space for containing the electrode assembly 110. The casing 120 is made of a conductive metallic material such as aluminum, an aluminum alloy, or steel plated with nickel. The upper portion of the casing 120 has an opening through which the electrode assembly 110 is inserted into the casing 120. Furthermore, the casing 120 includes a beading portion 123 and a crimping portion 125 that are formed in the process of fastening the electrode assembly 110 and the safety vent 142 that are located inside the casing 120. In addition, an electrolyte solution (not shown) is injected into the casing 120. Thus, lithium ions generated in an electrochemical reaction at the cathode 112 and the anode 114 during charging and discharging can be transferred. Although the casing 120 is described and shown as being substantially cylindrical in shape, aspects of the present invention are applicable to casings of varying shapes.

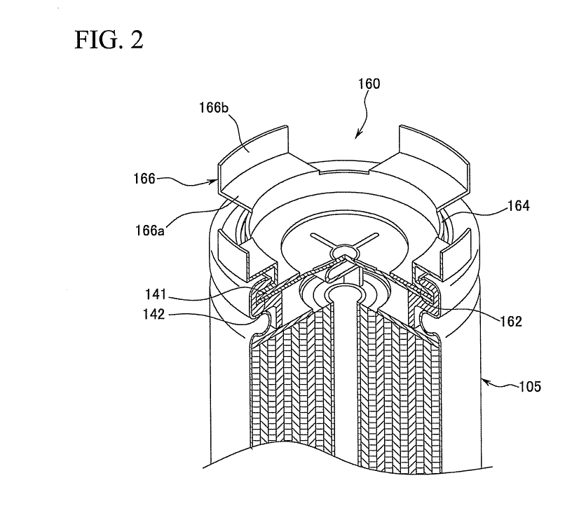

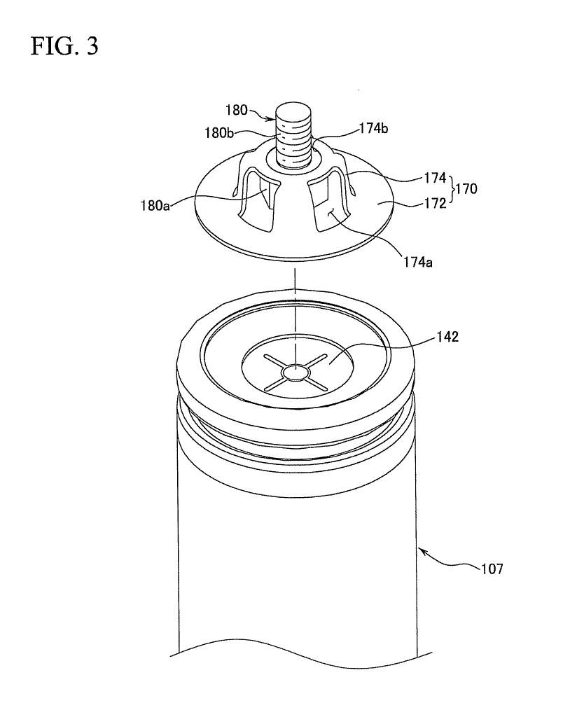

The gasket 144 is disposed between the casing 120 and the positive temperature coefficient element 141 and the safety vent 142 to surround circumferences of the positive temperature coefficient element 141 and the safety vent 142 so as to insulate the positive temperature coefficient element 141 and the safety vent 142 from the casing 120. Moreover, the gasket 144 of the first rechargeable battery 105 further surrounds the lateral side of a cap base 162 (see FIG. 2) of the vertical connection electrode cap 160. The gasket 144 of the second rechargeable battery 107 further surrounds the lateral side of a supporting plate 172 (see FIG. 3) of the horizontal connection electrode cap 170.

As the safety, the second rechargeable battery 107 employs the safety vent 142. Selectively, the positive temperature coefficient element 141 can also be used as the safety together with the safety vent 142. Further, a separate safety may be further provided to avoid overcharging, over-discharging, overheating, and an abnormal current.

According to aspects of the present invention, an example of the safety includes the positive temperature coefficient element 141, as well as the safety vent 142. However, aspects of the present invention are not limited to these. Therefore, it is possible that only the safety vent 142 is employed as the safety, but not the positive temperature coefficient element 141.

A lower side of the safety vent 142 is fixed to the anode tab 134 that has been drawn out from the anode 114 by welding or the like. When an internal pressure of the second rechargeable battery 107 increases to exceed a predetermined pressure, the safety vent 142 is moved upwardly, and thus the safety vent 142 is electrically disconnected from the anode 114. In the present embodiment, the safety vent 142 is directly connected to the anode tab 134. However, the safety vent 142 may employ another structure in which an insulation member (not shown) and a cap plate (not shown) are further sequentially laminated on the lower portion of the safety vent 142, and the anode tab 134 is coupled to the cap plate.

The positive temperature coefficient element 141 is connected to an upper portion of the safety vent 142. The positive temperature coefficient element 141 is a device of which resistance increases to be nearly infinite at a temperature exceeding a predetermined temperature. When the temperature of the second rechargeable battery 107 exceeds the predetermined temperature, the positive temperature coefficient element 141 stops the flow of charge or discharge current. In addition, when the temperature of the second rechargeable battery 107 decreases below the predetermined temperature, the resistance of the positive temperature coefficient element 141 decreases again. Therefore, upon cooling, the second rechargeable battery 107 can be used.

The vertical connection electrode cap 160 is disposed between the upper portion of the safety vent 142 of the first rechargeable battery 105 and the lower side of the casing of the second rechargeable battery 107 so that the first rechargeable battery 105 and the second rechargeable battery 107 can be electrically connected.

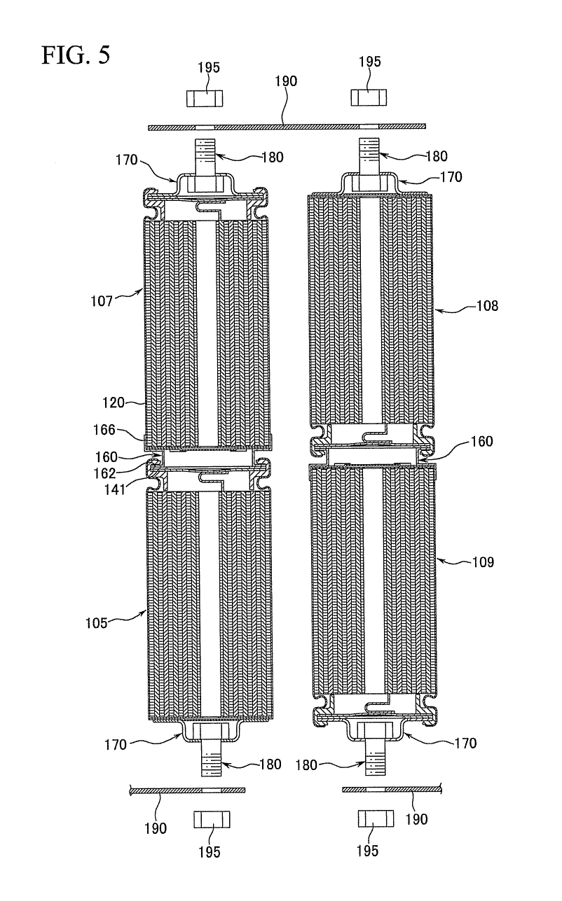

The horizontal connection electrode cap 170 is electrically connected to the upper portion of the positive temperature coefficient element 141 of the second rechargeable battery 107, and thus acts as an anode terminal for applying current to an external circuit. A fixture is disposed inside the horizontal connection electrode cap 170. In the present embodiment, a bolt 180 is used as the fixture. The bolt 180 may be fixed to a conductor 190 (see FIG. 5) whereby the second rechargeable battery 107 is connected to a third rechargeable battery 108 (see FIG. 5) adjacent to the second rechargeable battery 107. Of course, when the second rechargeable battery 107 is not connected with the third rechargeable battery 108, the bolt 180 need not be connected to the horizontal connection electrode cap 170.

The vertical connection electrode cap 160 includes a cap base 162, a connection portion 164, and a plurality of accommodating portions 166 each having a bottom member 166a and a lateral member 166b. The vertical connection electrode cap 160 and the horizontal connection electrode cap 170 will be described in detail with reference to FIGS. 2 and 3. FIG. 2 is a partial cross-sectional view of FIG. 1 in a state that the first rechargeable battery 105 is connected to the vertical connection electrode cap 160. As shown in FIG. 2, the vertical connection electrode cap 160 includes the cap base 162, a connection portion 164, and a plurality of accommodating portions 166.

In the present embodiment, the cap base 162 has an annular shape or a disc shape having an aperture therethrough and is disposed on the positive temperature coefficient element 141 and the safety vent 142 of the first rechargeable battery 105. The gasket 144 of the first rechargeable battery 105 is formed to surround the periphery of the cap base 162. Thus, the cap base 162 can be insulated from the casing 120. Further, the cap base 162 may include a notch.

The connection portion 164 protrudes from an inner edge of the cap base 162 in a direction away from the safety vent 142 or toward the second rechargeable battery 107, i.e., the connection portion 164 extends from the cap base 162 toward the second rechargeable battery 107 about the aperture extending through the disc shape. In the present embodiment, the connection portion 164 has a vertically hollow cylindrical shape or an open cylindrical shape extending from the cap base 162 toward the second rechargeable battery 107.

The plurality of accommodating portions 166 are disposed to extend in a bent shape radially outward from the end of the connection portion 164 disposed away from the first rechargeable battery 105 and then bent laterally toward the second rechargeable battery 107 (of FIG. 1). Each accommodating portion 166 includes a bottom member 166a that is formed along the end of the connection portion 164 disposed away from the first rechargeable battery 105 and each bottom member 166a is equally spaced apart from each adjacent bottom member 166a. Each bottom member 166a has a lateral member 166b connected thereto that extends in the lateral direction away from the first rechargeable battery 105. Each lateral member 166b is attached to an end portion of a bottom member 166a at an end of the bottom member 166a disposed away from a center of the first rechargeable battery 105.

In other words, a first edge of each bottom member 166a is connected to the connection portion 164 at an edge of the connection portion disposed away from a portion in which the cap base 162 is connected to the connection portion 164. Further, each bottom member 166a is substantially parallel to the cap base 162. Each lateral member 166b is connected to a second edge of each bottom member 166a, the second edge being disposed away from the center of the first rechargeable battery 105, and protrudes from the second edge thereof in a direction away from the cap base 162. In the present embodiment, the vertical connection electrode cap 160 has a plurality of accommodating portions as an example. However, aspects of the present invention are not limited thereto. Thus, the vertical connection electrode cap may have one accommodating portion comprising one bottom member having a ring shape, and one lateral member continuously formed along an external circumference of the bottom member.

The accommodating portion 166 having such a structure accommodates the lower portion of the casing 120 of the second rechargeable battery 107. That is, the lateral members 166b of the accommodating portion 166 are coupled to the lower lateral side of the casing 120 of the second rechargeable battery 107. In this case, the safety vent 142 of the first rechargeable battery 105 faces the lower side of the casing 120 of the second rechargeable battery 107. Meanwhile, the lateral members 166b of the accommodating portion 166 may be connected to the lower lateral side of the casing 120 of the second rechargeable battery 107 by resistance welding or laser welding. The upper and lower portions of the second rechargeable battery 107 as used herein refer to ends of the second rechargeable battery 107 nearer the anode tab 134 and the lower insulating plate 136 (both of FIG. 1), respectively, regardless of orientation in the drawings.

FIG. 3 is an exploded perspective view illustrating the second rechargeable battery 107 and the horizontal connection electrode cap 170 of FIG. 1. Referring to FIG. 3, the horizontal connection electrode cap 170 includes the supporting plate 172 and a cover portion 174. The bolt 180 is disposed inside the horizontal connection electrode cap 170.

In the present embodiment, the supporting plate 172 has an annular shape or a disc shape having an aperture therethrough and is disposed on the positive temperature coefficient element 141 of the second rechargeable battery 107. The gasket 144 (not shown) of the second rechargeable battery 107 surrounds the lateral side of the supporting plate 172, and thus the supporting plate 172 can be insulated from the casing 120.

The cover portion 174 protrudes from an inner edge of the supporting plate 172. An exhaust outlet 174a is formed in the lateral side of the cover portion 174. A hole 174b is formed on the upper side of the cover portion 174. The exhaust outlet 174a serves as a path through which gas existing inside the second rechargeable battery 107 can be discharged to the outside when the safety vent 142 is broken. A screw 180b of the bolt 180 passes through the hole 174b.

The bolt 180 includes a body 180a and the screw 180b. The body 180a is fixed to the inner upper side of the cover portion 174 by welding. The screw 180b, integrated with the body 180a, passes through the hole 174b of the cover portion 174.

The horizontal connection electrode cap 170, including the bolt 180, is an element required to electrically connect the third rechargeable battery 108 (see FIG. 5) adjacent to the second rechargeable battery 107.

If the third rechargeable battery 108 is not connected to the second rechargeable battery 107, the hole 174b and the bolt 18 need not be formed in the horizontal connection electrode cap 170.

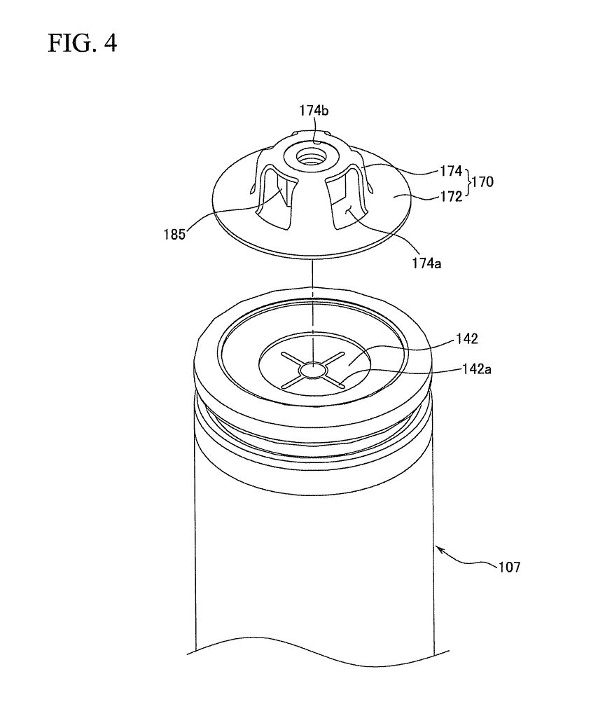

In the present embodiment, the bolt 180 is formed in the cover portion 174 as a fixture. However, the fixture is not limited to the bolt 180. FIG. 4 illustrates a battery module according to another embodiment of the present invention. The battery module has a structure in which a nut 185 is coupled to the cover portion 174 of the horizontal connection electrode cap 170. In this case, the hole 174b of the cover portion 174 may be aligned to a center line of the nut 185.

The horizontal connection electrode cap 170 and the fixtures (i.e., the bolt 180 and the nut 185) are provided to electrically connect a plurality of rechargeable batteries arranged in parallel in a horizontal direction, i.e., to electrically connect a plurality of rechargeable batteries that are next to each other and not end-to-end in a longitudinal direction, whereas the aforementioned vertical connection electrode cap 160 is provided to electrically connect a plurality of rechargeable batteries arranged in a longitudinal direction, i.e., to electrically connect a plurality of rechargeable batteries arranged end-to-end in a longitudinal direction. Now, the horizontal connection electrode cap 170 and the vertical connection electrode cap 160 will be described in detail with reference to FIG. 5.

FIG. 5 is a cross-sectional view of first through fourth rechargeable batteries 105, 107, 108, and 109 interconnected using the horizontal connection electrode cap 170 and the vertical connection electrode cap 160. For better understanding and ease of description, only the first through fourth rechargeable batteries 105, 107, 108, and 109 are shown in the present embodiment. However, the number of rechargeable batteries is not limited thereto. Referring to FIG. 5, the first through fourth rechargeable batteries 105, 107, 108, and 109 are connected in series using the vertical connection electrode cap 160, the horizontal connection electrode cap 170, the bolt 180, a fastening nut 195, and the conductor 190.

The second rechargeable battery 107 is located at the upper portion of the first rechargeable battery 105. The vertical connection electrode cap 160 is disposed between the first rechargeable battery 105 and the second rechargeable battery 107. The first rechargeable battery 105 and the second rechargeable battery 107 are connected in series using the vertical connection electrode cap 160.

The connection structure thereof will now be described in greater detail. The cap base 162 of the vertical connection electrode cap 160 is disposed on the positive temperature coefficient element 141 of the first rechargeable battery 105. The lower lateral side of the casing 120 of the second rechargeable battery 107 is coupled to the accommodating portions 166 of the vertical connection electrode cap 160. As a result, the first rechargeable battery 105 and the second rechargeable battery 107 are electrically connected.

Also, the third rechargeable battery 108 and the fourth rechargeable battery 109 are connected in the same manner as the first rechargeable battery 105 and the second rechargeable battery 107.

Meanwhile, as described above, the upper portion of the second rechargeable battery 107 is provided with the horizontal connection electrode cap 170 and the bolt 180. Likewise, the upper portion of the fourth rechargeable battery 109 is provided with the horizontal connection electrode cap 170 and the bolt 180. The lower sides of the casings 120 of the first rechargeable battery 105 and the third rechargeable battery 108 are provided with horizontal connection electrode caps 170. Bolts 180 are disposed inside the horizontal connection electrode caps 170. The upper and lower portions of the first through fourth rechargeable batteries 105, 107, 108, and 109 as used herein refer to ends of the first through fourth rechargeable batteries 105, 107, 108, and 109 nearer the anode tab 134 and the lower insulating plate 136 (both of FIG. 1), respectively, regardless of orientation in the drawings. Further, the upper portions of the first through fourth rechargeable batteries 105, 107, 108, and 109 correspond to first terminals thereof; and the lower portions of the first through fourth rechargeable batteries 105, 107, 108, and 109 correspond to second terminals thereof.

As illustrated in FIG. 5, the horizontal connection electrode caps 170 of the second rechargeable battery 107 and the fourth rechargeable battery 109 are anode terminals, while the horizontal connection electrode caps 170 of the first rechargeable battery 105 and the third rechargeable battery 108 are cathode terminals. However, aspects of the present invention are not limited thereto.

A conductor 190 is disposed over or about the bolt 180 disposed in the horizontal connection electrode cap 170 of the second rechargeable battery 107 and the bolt 180 disposed in the horizontal connection electrode cap 170 of the third rechargeable battery 108. Thereafter, fastening nuts 195 are joined to the bolts 180. As a result, the conductors 190 are fixed to the horizontal connection electrode caps 170 of the second rechargeable battery 107 and the third rechargeable battery 108. Accordingly, the anode of the second rechargeable battery 107 is coupled in series with the cathode of the third rechargeable battery 108. Further, the conductor 190 electrically connects the second and third rechargeable batteries 107 and 108 in an adjacent fashion such that the first terminal of the second rechargeable battery 107 and the second terminal of the third rechargeable battery 108 are adjacent, and the second terminal of the second rechargeable battery 107 and the first terminal of the third rechargeable battery 108 are adjacent.

In addition, the first rechargeable battery 105 may be coupled in series with a fifth rechargeable battery (not shown) by the horizontal connection electrode cap 170, the bolt 180, and the conductor 190 each of which is connected to the lower side of the casing 120 of the first rechargeable battery 105. Moreover, the fourth rechargeable battery 109 may also be coupled in series with a sixth rechargeable battery (not shown) by the horizontal connection electrode cap 170, the bolt 180, and the conductor 190 of the fourth rechargeable battery 109.

As described above, according to the exemplary embodiments of the present invention, a plurality of rechargeable batteries arranged in a longitudinal direction can be interconnected using only a vertical connection electrode cap without having to use a connection member used in a conventional battery module. In addition, a plurality of rechargeable batteries arranged next to each other can be connected using only a horizontal connection electrode cap without having to use a separate connection member. Here, the horizontal connection electrode cap is coupled to the uppermost and/or lowermost rechargeable battery among the plurality of rechargeable batteries arranged in the longitudinal direction. In this case, the horizontal connection electrode cap may be connected to an anode terminal (or cathode terminal) of the rechargeable battery.

While aspects of the present invention have been particularly shown and described with reference to exemplary embodiments thereof, the exemplary embodiments should be considered as description only and not for purposes of limitation. Thus, it will be understood by those skilled in the art that various changes in form and details may be made therein without departing from the spirit and scope of the invention as defined by the appended claims.

According to the exemplary embodiments of the present invention, a plurality of rechargeable batteries can be connected using only a vertical connection electrode cap and a horizontal connection electrode cap without having to use a separate connection member. Therefore, the rechargeable batteries can be connected with a simpler structure and resistance produced in a connection area is decreased when compared with the conventional case.

In addition, as the separate connection member is not required to connect the rechargeable batteries, the battery module can be realized with fewer elements. Thus, the cost of the battery module can be decreased.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A battery module, comprising:
a first rechargeable battery and a second rechargeable battery each having a safety and first and second terminals; and
a first connection electrode cap that is disposed between the first terminal of the first rechargeable battery and the second terminal of the second rechargeable battery, wherein the first connection electrode cap comprises:
a cap base disposed on the safety of the first rechargeable battery,
a connection portion that extends from the cap base toward the second rechargeable battery, the connection portion extending from an inner edge of the cap base, and
at least one accommodating portion extending from the connection portion to accommodate the second rechargeable battery.

2. The battery module of claim 1, wherein the cap base has a disc shape with an aperture therethrough, the inner edge of the cap base defining the aperture.

3. The battery module of claim 2, wherein the connection portion extends toward the second rechargeable battery about an outside of the casing of the second rechargeable battery.

4. The battery module of claim 2, wherein the connection portion has an open cylindrical shape.

5. The battery module of claim 1, wherein each accommodating portion includes:
a bottom member having a first end connected to an end of the connection portion opposite the cap base, and the bottom member extends outwardly and radially from the end of the connection portion to a second end of the bottom member, and the bottom member is parallel to the cap base; and
a lateral member connected to the second end of the bottom member and extends from the second end of the bottom member in a direction away from the cap base.

6. The battery module of claim 5, wherein the at least one accommodating portion includes a plurality of accommodating portions, and
each accommodating portion is equally spaced from each adjacent accommodating portion about a circumference of the connection portion.

7. The battery module of claim 1, wherein each accommodating portion is formed in a bent shape, first extending outwardly and radially from the connection portion and then extending therefrom toward the second rechargeable battery.

8. The battery module of claim 1,
wherein the first rechargeable battery further includes a gasket, the gasket surrounding a periphery of the safety of the first rechargeable battery and a periphery of the cap base.

9. The battery module of claim 8, wherein the safety of the first rechargeable battery faces a lower side of the second rechargeable battery.

10. The battery module of claim 1, further comprising:
a second connection electrode cap disposed on the safety of the second rechargeable battery; and
a fixture fixed to the second connection electrode cap.

11. The battery module of claim 10,
wherein the second rechargeable battery further includes a gasket, the gasket surrounding a periphery of the safety of the second rechargeable battery and a periphery of the second connection electrode cap.

12. The battery module of claim 11, wherein the second connection electrode cap includes:
a supporting plate that is disposed on the safety of the second rechargeable battery and has a disc shape with an aperture therethrough; and
a cover portion protruding from an inner edge of the supporting plate away from the second rechargeable battery and having a hole in a center of the cover portion.

13. The battery module of claim 12, wherein the fixture is fixed to a side of the cover portion nearer the second rechargeable battery.

14. The battery module of claim 13, wherein the fixture is a nut that accepts a bolt to secure the second rechargeable battery in the battery module.

15. The battery module of claim 12,
wherein the fixture is a bolt having a body and a screw integrated with the body, the body being fixed to a side of the cover portion nearer the second rechargeable battery and the screw extending away from the second rechargeable battery through the hole in the cover portion.

16. The battery module of claim 10, further comprising:
a conductor to electrically connect the second rechargeable battery to a third rechargeable battery having a safety and first and second terminals;
wherein the second connection electrode cap is disposed between the first terminal of the second rechargeable battery and the conductor, and another second connection electrode cap disposed between the second terminal of the third rechargeable battery and the conductor.

17. The battery module of claim 16, wherein the conductor electrically connects the second and third rechargeable batteries in an adjacent fashion such that the first terminal of the second rechargeable battery and the second terminal of the third rechargeable battery are adjacent, and the second terminal of the second rechargeable battery and the first terminal of the third rechargeable battery are adjacent.

18. A battery module, comprising:
a first rechargeable battery and a second rechargeable battery each having an electrode assembly constructed of an anode, a cathode, and a separator disposed between the anode and the cathode, a casing to contain the electrode assembly, a safety disposed at an upper portion of the casing, and a gasket disposed between the casing and the safety to surround a periphery of the safety; and
a first connection electrode cap disposed between the first rechargeable battery and the second rechargeable battery to connect the first rechargeable battery and the second rechargeable battery, the first and second rechargeable batteries being arranged in a longitudinal direction,
wherein a first end of the first connection electrode cap is disposed on the safety of the first rechargeable battery and is surrounded by the gasket of the first rechargeable battery, and a second end of the first connection electrode cap is coupled to the casing of the second rechargeable battery.

19. The battery module of claim 18, wherein the first connection electrode cap includes:
a cap base disposed on the safety of the first rechargeable battery;
a connection portion extends from the cap base toward the second rechargeable battery, the connection portion extending from an inner edge of the cap base; and
at least one accommodating portion extending from the connection portion to accommodate the second rechargeable battery.

20. A battery module, comprising:
a first rechargeable battery, a second rechargeable battery, and a third rechargeable battery each having an electrode assembly, a casing to contain the electrode assembly, a safety disposed in an upper portion of the casing, and a gasket surrounding a periphery of the safety;
a first connection electrode cap that is disposed between the first rechargeable battery and the second rechargeable battery to connect the first rechargeable battery and the second rechargeable battery, the first and second rechargeable batteries being arranged in a longitudinal direction;
a second connection electrode cap disposed in each of the second rechargeable battery and the third rechargeable battery arranged in an adjacent direction; and
a first conductor connected to the second connection electrode cap of the second rechargeable battery and the second connection electrode cap of the third rechargeable battery,
wherein the second connection electrode cap disposed in the second rechargeable battery is disposed on the safety of the second rechargeable battery, and the second connection electrode cap disposed in the third rechargeable battery is connected to the casing of the third rechargeable battery in a lower portion of the casing, and the gasket of the second rechargeable battery surrounds the safety of the second rechargeable battery and a periphery of the second connection electrode cap disposed in the second rechargeable battery.

21. The battery module of claim 20, wherein the second connection electrode cap includes:
a supporting plate having a disc shape with an inner edge defining an aperture therethrough; and
a cover portion extending from the inner edge of the supporting plate away from the rechargeable battery to which the cover portion is attached.

22. The battery module of claim 20, wherein the second connection electrode cap disposed to the second rechargeable battery is electrically connected to an anode of the second rechargeable battery, and the second connection electrode cap disposed to the third rechargeable battery is electrically connected to a cathode of the third rechargeable battery.

23. The battery module of claim 20, further comprising:
another second connection electrode cap disposed in the first rechargeable battery connected to the casing of the first rechargeable battery in a lower portion of the casing; and
a second conductor connected to the second connection electrode cap of the first rechargeable battery and yet another second connection electrode cap of another rechargeable battery.
